(19) United States
(12) Patent Application Publication
(10) Pub. No.: US 2025/0315790 A1
(43) Pub. Date: Oct. 9, 2025

(54) SYSTEM, WORKER DETECTION AND REPORTING DEVICE, METHOD AND COMPUTER-READABLE MEDIUM FOR PROJECT MANAGEMENT

(71) Applicant: 2869609 Ontario Inc. d.b.a. Plumbata Intelligent Business Solutions, Skead (CA)

(72) Inventor: William McCormick, Skead (CA)

(21) Appl. No.: 19/241,720

(22) Filed: Jun. 18, 2025

Related U.S. Application Data
(63) Continuation-in-part of application No. 18/346,833, filed on Jul. 4, 2023.

(51) Int. Cl. G06Q 10/10; G06Q 10/0631; H04W 4/029

(52) U.S. Cl. CPC G06Q 10/103; G06Q 10/063114; H04W 4/029

(57) ABSTRACT

A system for managing a project comprises a worker detection and reporting device (WDRD) for detecting workers working at a site of a project. The WDRD includes a short-range wireless receiver to detect short-range wireless signals from a plurality of worker devices to determine worker presence and generates shift report data for the workers. The WORD includes a cellular radiofrequency transceiver to transmit the shift report data. The system includes a server receiving the shift report data and also receiving progress data indicative of progress on the project. The server executes a labour management module having, or interacting with, an artificial intelligence module analyzing the shift report data to determine if the shift report data complies with contractual requirements and correlates to expected progress on the project and to generate an alert report. A computing device associated with a project owner has a user interface to present the alert report.

### CROSS-REFERENCE TO RELATED APPLICATIONS

This application is a continuation-in-part (CIP) of U.S. patent application Ser. No. 18/346,833, filed Jul. 4, 2023, the disclosure of which is incorporated herein by reference in its entirety.

### TECHNICAL FIELD

The present invention relates generally to computer-implemented systems, devices, computer-implemented methods and computer-readable media for project management and, more particularly, to systems, devices, methods and computer-readable media for managing labour costs in a project.

### BACKGROUND

Various known project management techniques are routinely employed for managing various types of projects, such as for example large-scale construction projects. Various computer-implemented technologies provide tools for specific aspects of project management have been developed. Some examples are disclosed in the following documents: U.S. Pat. Nos. 10,042,636, 11,321,791, 8,244,565, US20200327467, US20190138961, US20170147960, US20130332368, and US20210110347, all of which are hereby incorporated by reference.

Despite these various tools and technologies, improvements in project management tools remain highly desirable. In particular, project cost overruns may arise due to mismanagement of labour costs. There is therefore a need for novel computer-implemented technologies for project management, particular in relation to management of labour costs.

### SUMMARY

A system for managing a project has a worker detection and reporting device (WDRD) for detecting workers working at a site of a project. The WDRD detects worker devices to determine worker presence and generates shift report data for the workers. The WDRD includes a cellular radiofrequency transceiver to transmit the shift report data. The system includes a server receiving the shift report data and progress data indicative of progress on the project. The server executes a labour management module to determine if the shift report data complies with contractual requirements and correlates to expected progress on the project and to generate an alert report if not. The system has a computing device associated with a project owner that receives the alert report and presents the alert report to the project owner.

In various embodiments, the system for managing a project comprises a worker detection and reporting device for detecting one or more workers working at a site of the project. The worker detection and reporting device has a processor, a memory coupled to the processor and a short-range wireless receiver coupled to the processor to detect short-range wireless signals from a plurality of worker devices associated with workers working the site of the project. The short-range wireless signal has a maximum signal range of 1 km. The processor of the worker detection and reporting device is configured to determine worker presence for the workers based on the short-range wireless signals from the plurality of worker devices and to generate shift report data for the workers indicative of work hours completed for a work shift at the site. The worker detection and reporting device has a cellular radiofrequency transceiver to transmit the shift report data via a base transceiver station and the internet. The system further includes a server comprising a server memory, a server processor, and a server data transceiver for receiving the shift report data from the worker detection and reporting device and also receiving progress data indicative of progress made on the project. The server memory and the server processor store and execute a labour management module having, or interacting with, an artificial intelligence module trained on past project data, the artificial intelligence module analyzing the shift report data to determine if the shift report data complies with contractual requirements and correlates to expected progress on the project and to generate an alert report if the shift report data does not comply with the contractual requirement or does not correlate to the expected progress on the project. The system further includes a computing device associated with a project owner. The computing device comprises a device memory, a device processor and a device data transceiver to communicatively connect the computing device via the internet to the server to receive the alert report. The computing device has a user interface cooperating with the device processor to present the alert report to the project owner.

Other aspects of the disclosure relate to a computing device and computer-readable medium for managing a project that has a labour management module to receive shift report data from one or more mobile devices associated with one or more workers working on the project, the shift report data including an electronic timesheet and a progress report. The labour management module determines a project status of the project to automatically generate an alert report and a recommendation. Another aspect of the disclosure relates to a computing device and computer-readable medium having a tender contract tender module to compare contractor labour rates with known labour rates to identify excessive labour rates.

The foregoing presents a simplified summary of the invention in order to provide a basic understanding of some aspects of the invention. This summary is not an exhaustive overview of the invention. It is not intended to identify essential, key or critical elements of the invention or to delineate the scope of the invention. Its sole purpose is to present some concepts in a simplified form as a prelude to the more detailed description that is discussed later. Other aspects of the invention are described below in relation to the accompanying drawings.

### BRIEF DESCRIPTION OF THE DRAWINGS

Further features and advantages of the present technology will become apparent from the following detailed description, taken in combination with the appended drawings, in which:

FIG. 1 is a schematic illustration of a computer system having a labour management module in accordance with an embodiment of the invention.

FIG. 2 is a schematic illustration of a computer system having a contract tender module in accordance with another embodiment of the invention.

FIG. 3 is a flowchart depicting a computer-implemented method of managing labour performed using the system of FIG. 1.

FIG. 4 is a flowchart depicting a computer-implemented method of preparing contract tenders performed using the system of FIG. 2.

FIG. 5 is a schematic illustration of a system having one or more worker detection and reporting devices for detecting workers on a construction site, one or more servers receiving shift reporting data from the one or more worker detection and reporting devices, and a computing device associated with a project owner to enable a project owner to track labour costs.

FIG. 6 is a schematic illustration of various types of worker detection and reporting devices that may be used on a site of a project to track worker presence.

FIG. 7 is a schematic illustration of a worker wearing a smart watch as an example of a wearable sensor, carrying a mobile communication device such as a smart phone, wearing a smart helmet emitting an RF beacon, and wearing an RFID tag all of which can be detected by a worker presence and reporting device.

FIG. 8 is a schematic depiction of a project site enclosed by a fence and gate and illustrating how a worker detection and reporting device, in this case a smart phone of a foreman, can detect worker presence by receiving signals from a proximity card reader, one or more RFID readers, a smart helmet emitting an RF beacon, a smart watch and wireless signals emitted by the mobile communication device carried by the worker.

FIG. 9 is a flowchart depicting a computer-implemented method of detecting worker presence, determining times worked by the workers, transmitting shift report data to a server to assess project cost and to generate an alert report.

It will be noted that throughout the appended drawings, like features are identified by like reference numerals.

### DETAILED DESCRIPTION

The following is a description of computer systems and computer-readable media (i.e. software applications) and related computer-implemented methods for project management. In one embodiment, the computer system, computer readable medium and method enable managing of labour, particularly labour costs. The computer system may have a computing device that stores and executes a labour management module as will be described in greater detail below. In another embodiment, the computer system, computer readable medium and method enable the creation of contract tenders. The computer system may have a computing device that stores and executes a contract tender module as will be described in greater detail below.

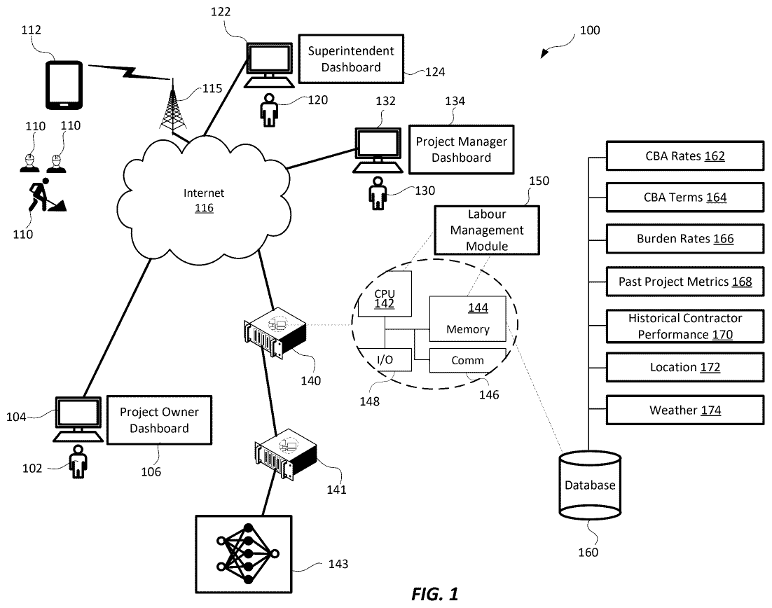

FIG. 1 illustrates a computer system for project management in accordance with one embodiment of the present invention. The computer system is generally denoted by reference numeral 100. The computer system 100 is designed to enable a user to manage a project, in particular to manage labour costs of a project. The computer system 100 includes a computing device 104 for a user 102. The user 102 in this instance is a project owner or project/workforce manager but could be any other person or entity tasked with managing the project in whole or in part. The computing device 104 may be a desktop computer or laptop. The computing device 104 includes a user interface for providing a project owner dashboard 106. The computing device includes a memory and a processor for storing and executing a labour management application or a web browser for accessing a labour management website having or interacting with a labour management module 150. The labour management application may be stored and executed in whole or in part by the computing device. A labour management module 150 may be stored and executed in whole or in part on a server 140 that collaborates with the computing device 104 in a client-server paradigm or in any other distributed computing or cloud computing environment. The computing device 104 may connect to the server 140 via the Internet 116 or other data network, which may involve a virtual private network (VPN). There may be a single server 140, a server cluster, server farm or cloud server. The computing device 104 has a modem, router or data switch to communicate with the server 140 over the Internet 116 using standard Transmission Control Protocol/Internet Protocol (TCP/IP) datagrams. The server 140 may be a web server using Hypertext Transfer Protocol (HTTP). Web applications may be coded using Hypertext Markup Language (HTML), Cascading Style Sheets (CSS) or JavaScript.

The computing device 104 and project owner dashboard 106 enable the user 102 to manage a workforce, i.e. to manage the work (labour) performed by one or more workers (labourers) 110 who are working on the project. The project may be a construction project but it may also be any other type of project. In the illustrated embodiment, the workers 110 use a mobile device 112 (or multiple mobile devices as the case may be) to communicate shift report data via a base transceiver station (cell tower) 115 through the Internet 116 to the server 140. In a variant, the workers 110 may use a wired data connection to communicate the shift report data. In some embodiments, the shift report data includes an electronic timesheet and a progress report. However, the shift report data may also include other information and data about the shift, the workers, project completion details, milestones, certifications from inspectors, photographs, etc.

The mobile device(s) 112 used by the worker(s) 110 to report their shift data may be a cell phone or smart phone, a tablet, or any other handheld communication device or wireless communications device. Shift data may be transmitted using a cellular transceiver to and from the server 140 via the base station 115 over a cellular wireless network using cellular communication protocols and standards for packet data transfer such as GSM, CDMA, General Packet Radio Service (GPRS), EDGE, UMTS, LTE, 5G, etc. As shown in FIG. 1, the mobile device 112 communicates over a cellular radiofrequency channel with a cell tower, i.e. a base transceiver station (BTS) 115 which routes the data packets to the Internet via the appropriate gateway depending on the cellular protocol (3G, 4G, 5G). As noted above, in a variant, the workers may use a wired data connection, e.g. a desktop computer or laptop computer having a modem or router connected to the internet to communicate the shift data report. Although it is envisioned that the workers transmit their shift report data to the server 140, in another implementation, the server 140 may prompt the workers to enter their shift report data. In a variant, if the workers do not send their shift report data by a certain time, the server sends a reminder to the worker or workers whose shift report data has not been received in a timely manner in order to prompt the worker or workers to reply with their shift report data. Optionally, if the labour management module identifies a discrepancy or non-compliant element of the shift data report such as an incorrect start time or end time, the labour management module can automatically transmit a query to the worker who submitted the shift data report to confirm that the non-compliant element of the shift data report was intentionally entered by the worker. Optionally, upon receipt of the confirmation, the labour management module can automatically notify the worker of the non-compliance with the contract. A copy of this notification can also be sent to the project/workforce manager. Optionally, prior to sending the notification to the worker, the labour management module can send a request to the project/workforce manager to confirm that the notification should be sent to the worker.

The mobile device 112 shown by way of example in FIG. 1 includes a microprocessor, memory, battery and a user interface. The user interface may include one or more input/output devices, such as a display screen. The mobile device optionally includes a microphone and a speaker. The mobile device 112 may include forwardly-facing and rearwardly-facing digital cameras. The mobile device includes a cellular radiofrequency (RF) transceiver. The mobile device also includes a location-determining subsystem for determining a current location of the user computing device. In the case of a mobile device, the location-determining subsystem may be a Global Navigation Satellite System (GNSS) chip such as a Global Positioning System (GPS) chip. The mobile device may also have a Wi-Fi transceiver, a Bluetooth transceiver, a near-field communication (NFC) chip, an accelerometer, and one or more other data communication ports or sockets for wired connections, e.g. USB, HDMI, Lightning connector, FireWire (IEEE 1394), etc. or ports or sockets for receiving non-volatile memory cards, e.g. SD (Secure Digital) card, miniSD card or microSD card.

The mobile device 112 shown by way of example in FIG. 1 may be used by each of the workers to input shift report data such as start time, end time, photos of progress, etc. The mobile device 112 may use the radiofrequency transceiver to transmit the shift report data via the base transceiver station 115 through the Internet 116 to the server 140.

As shown in FIG. 1, the computer system may communicate updates, alerts or reports to a project/workforce manager 120, e.g. a superintendent, by transmitting data to a project/workforce manager computing device 122 (e.g. superintendent computing device) for display on a project/workforce manager dashboard 124 (e.g. superintendent dashboard).

As further shown by way of example in FIG. 1, the computer system may communicate updates, alerts or reports to another project/workforce manager involved in the project, e.g. to a project manager 130 by transmitting data to a project manager computing device 132 for display on a project manager dashboard 134.

The server 140 may have a central processing unit (CPU) 142, a memory 144, a communication interface 146 and an input/output (I/O) device 148. The labour management module 150 may be stored in the memory 144 and executed by the CPU 142.

As depicted by way of example in FIG. 1, the server 140 may be communicatively connected to an additional server 141 or to a plurality of other servers to execute an artificial intelligence (AI) module 143. The AI module 143 can be trained to recognize correlations between data sets to efficiently and intelligently manage labour in a project. The artificial intelligence module may be configured to automatically generate an alert report and a recommendation by comparing the shift report data with the progress indicated in the progress report.

As depicted by way of example in FIG. 1, the memory 144 of the server 140 may also store a database 160 of project management data. This project management data may include collective bargaining agreement (CBA) rates 162, CBA terms 164, burden rates 166, past project metrics 168, historical contractor performance 170, location 172 and weather 174. Other types of data may optionally be included.

From the above description and from the depiction of FIG. 1, it should be understood that the computing device executing the labour management module may be either the computing device 104 and/or server 140, both of which comprise a memory for storing the labour management module 150, a processor cooperating with the memory for executing the labour management module 150, and a data transceiver cooperating with the processor and the memory to receive shift report data from one or more mobile devices 112 associated with one or more workers 110 working on the project, the shift report data including an electronic timesheet and a progress report. The shift report data may include a contract identifier, a worker identifier, a trade union name, location, shift type, date, start and end time. The shift report data may be for an individual or a group of workers. The labour management module 150 determines collective bargaining agreement rates from the trade union name and the location and compares collective bargaining terms with the shift type, date, start and end time. The labour management module 150 determines a project status of the project in response to receiving the shift report data. A user interface of the computing device cooperating with the processor automatically generates and presents an alert report relating to the project status and a recommendation for managing the project. The project status may include a financial status (projected to be on budget, exceeding budget, under budget) and/or a time status (projected to be completed on time, running late or to be completed early). The project status may be expressed in terms of monetary values (dollars, euros, yen, etc.) or as a percentage of the overall project cost (10% over budget, 20% over budget, etc). Likewise, time status may be expressed in terms of any unit of time, e.g. days, weeks, months, etc. or as a percentage of the original time allocated (e.g. 5% longer than planned, 10% longer than planned, etc.) The project status may also compute and display an indication of any time-based penalties that the project manager and/or construction company may be liable to pay for completing the project late pursuant to the contract.

In one specific implementation, the alert report comprises an alert that a project cost has exceeded a predetermined cost threshold for a progress indicated in the progress report and the recommendation is automatically transmitted to a project/workforce manager device associated with a project/workforce manager (e.g. superintendent or project manager) of the one or more workers, e.g. to computing devices 122, 132.

In one particular exemplary implementation, the labour management module 150 comprises a plurality of business rules derived from one or more of collective bargaining agreement rates, collective bargaining agreement terms, past projects, historical contractor performance, local market conditions, and weather. Data for the business rules may be stored in a database 160. In one specific exemplary implementation, the labour management module 150 has a business rule that compares a start time and an end time from the shift report data with CBA terms to determine if the start time and/or end time gives rise to excess labour cost (e.g. overtime cost). If so, the labour management module 150 generates and sends an alert to a project/workforce manager. The alert may include a recommendation to change the start time and/or end time. In another specific exemplary implementation, the labour management module 150 has a business rule that compares a total amount of time worked for a particular worker over a period of time against CBA terms to determine if the particular worker is exceeding the maximum amount of time permitted by the CBA without incurring excess costs. If so, the labour management module 150 generates and sends an alert to a project/workforce manager. The alert may include a recommendation to replace the worker with a different worker or to add a further worker.

The concept of business rules is best demonstrated using an example. In the instance below, John Doe, a member of the IBEW 1687 trade union in Northern Ontario, has worked 33 hours from Monday to Wednesday. Under article 806 of IBEW 1687's collective bargaining agreement, John must be paid double-time for each hour worked in excess of 36 hours for the week. The combination of field data in the shift report will be applied against the business rules. As the criteria for a business rule is met, this will trigger an alert. The alert will be sent to the project/workforce manager (e.g. to a contract manager), with a recommendation to increase the crew size or rotate John Doe off as soon as possible. This will minimize the double-time hours for the remainder of the week.

To demonstrate the complexity and quantity of the business rules: IBEW has 11 local unions in Ontario. Each local union has approx. 200 CBA rates and 500 CBA terms (rules that impact the labour rates). In total, IBEW has approx. 2,200 CBA rates and 5,500 CBA terms to consider. Extending this concept across the 7 major construction trade unions in Ontario, there are more than 15,000 CBA rates and 38,000 CBA terms. The labour management module stores CBA rates and terms that either manually entered or automatically extracted from CBA documents.

When comparing timesheets against physical progress, the labour management module identifies that actual hours will exceed budgeted hours. The software creates an alert that is included in the project director report.

For example, a crew of electricians has a consistent start time of 6:00 am. which is outside the regular hours under the collective bargaining agreement of 8:00 am to 4:30 pm and results in double-time for two hours per day. In this example, the labour management module creates an alert that is included in the project/workforce manager report (e.g. contract manager report) with a recommendation to change the start time to 8:00 am.

As a further example, a crew of workers is consistently working excessive hours. The labour management module identifies that this trend only occurs when a particular superintendent is approving timesheets, which could indicate collusion between parties. This information is added to the project/workforce manager report (e.g. project director report) for review. For example, a crew of electricians has worked 12 hour shifts for three consecutive days on a project for which the governing collective agreement stipulates that 8 hours are regular time and 4 is paid at double time. The labour management module creates a trend alert to advise a project/workforce manager to consider adding an additional crew.

As a further example, some labourers are consistently working excessive hours on a weekly basis. The labour management module notices that this trend only seems to occur when a particular superintendent (owner's representative) is approving timesheets. The labour management module alerts the project/workforce manager that this could be due to potential collusion between parties. The labour management module can generate an escalated exception report for the project/workforce manager (e.g. project director) for review.

As yet a further example, the labour management module compares submitted timesheets against physical progress in the field and identifies a trend that predicts that labour cost will exceed budget based on current progress. The labour management module can generate an alert or escalated risk report based on this trend and transmit this alert or escalated risk report to the project/workforce manager (e.g. project director) for review.

The labour management module can be used to collect real-time field data required for efficient labour management. Examples of field data include contract number, employee name, worker ID, trade union, location, job classification, shift type, start and end time, and physical progress against milestones. The labour management module is able to apply the field data against business rules, derived from trade data. The key trade data used to develop business rules are, for example be, CBA rates and terms. However, other data may be used as well, such as burden rates, metrics and results from past projects, historical contractor performance, and local market conditions. The labour management module provides insight and recommendations to management in real-time to help management make better labour management decisions.

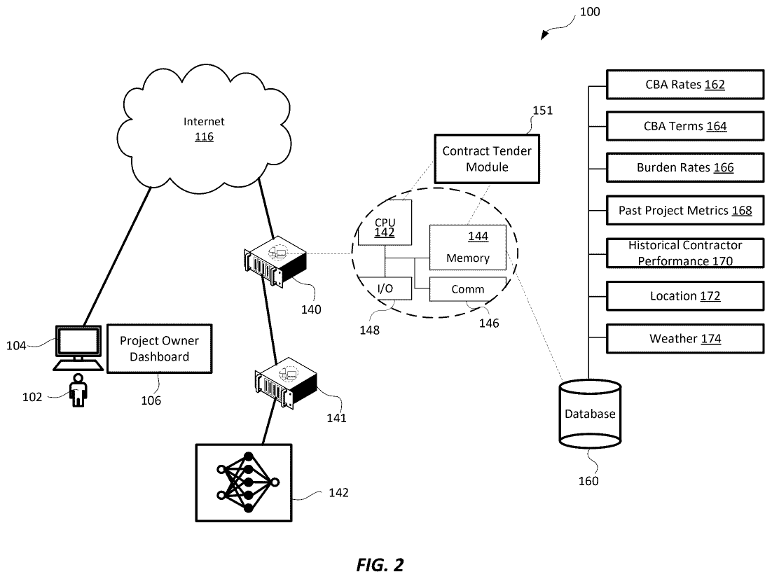

FIG. 2 illustrates a computer system for project management in accordance with another embodiment of the present invention. The computer system 100 of FIG. 2 is designed to enable a user to manage a project, in particular to prepare contract tenders for a project. Analogous in some respects to the system of FIG. 1, the computer system 100 depicted by way of example in FIG. 2 includes a computing device 104 for a user 102 who is the project owner, project/workforce manager or any other person or entity tasked with managing the project in whole or in part. The computing device 104 includes a user interface for providing a project owner dashboard 106. The computing device includes a memory and a processor for storing and executing a contract tender module 151. The contract tender module 151 may be stored and executed in whole or in part by the computing device. The contract tender module 151 may be stored and executed in whole or in part on a server 140 that collaborates with the computing device 104 in a client-server paradigm or in any other distributed computing or cloud computing environment. The computing device 104 may connect to the server 140 via the Internet 116 or other data network, which may involve a virtual private network (VPN). There may be a single server 140, a server cluster, server farm or cloud server. The computing device 104 has a modem, router or data switch to communicate with the server 140 over the Internet 116 using standard Transmission Control Protocol/Internet Protocol (TCP/IP) datagrams. The server 140 may be a web server using Hypertext Transfer Protocol (HTTP). Web applications may be coded using Hypertext Markup Language (HTML), Cascading Style Sheets (CSS) or JavaScript.

The computing device 104 and project owner dashboard 106 enable the user 102 to prepare a contact tender for work to be performed by one or more workers (labourers) 110 on a prospective project to be undertaken. The project may be a construction project but it may also be any other type of project.

In FIG. 2, as shown by way of example, the server 140 has a central processing unit (CPU) 142, a memory 144, a communication interface 146 and an input/output (I/O) device 148. The contract tender module 151 may be stored in the memory 144 and executed by the CPU 142.

As depicted by way of example in FIG. 2, the server 140 may be communicatively connected to an additional server 141 or to a plurality of other servers to execute an artificial intelligence (AI) module 143. The AI module 143 can be trained to recognize correlations between data sets to enable efficient creation of contract tenders.

As depicted by way of example in FIG. 2, the memory 144 of the server 140 may also store a database 160 of project management data to enable efficient and intelligent creation of contract tenders. This project management data may include collective bargaining agreement (CBA) rates 162, CBA terms 164, burden rates 166, past project metrics 168, historical contractor performance 170, location 172 and weather 174. Other types of data may optionally be included.

From the above description and from the depiction of FIG. 2, it should be understood that the contract tender module 151 can be executed by the computing device 104 or the server 140, both of which have a memory for storing a contract tender module and a processor cooperating with the memory for executing the contract tender module 151. The contract tender module 151 generates a labour bid form. A data transceiver cooperating with the processor and the memory transmits the labour bid form receives a plurality of contractor bids specifying contractor labour rates. The contract tender module 151 wherein the contract tender module executed by the processor compares the contractor labour rates in the contractor bids with a database of known labour rates established by one or more collective bargaining agreements, and identifies excessive labour rates. A user interface cooperating with the processor to automatically generate and present a report identifying the excessive labour rates.

In one implementation, the contract tender module 151 calculates contractor margins by comparing the contractor labour rates to the known labour rates established by the one or more collective bargaining agreements.

In one implementation, the contract tender module 151 also compares the contractor bids based on collective bargaining agreement terms, past project data, historical contractor performance, and local market conditions.

The contact tender module integrates CBA rates, which reflect the labour costs to contractors, into the bid evaluation process. This will enable project owners to accurately identify contractor margins by labour code. Identifying these margins will help project owners flag excessive labour rates and successfully negotiate them down.

The foregoing computer systems and computing devices can be used to perform novel computer-implemented methods of managing projects. These computer-implemented methods may be implemented as computer-readable media, i.e. software applications for storing and executing on one or more computing devices.

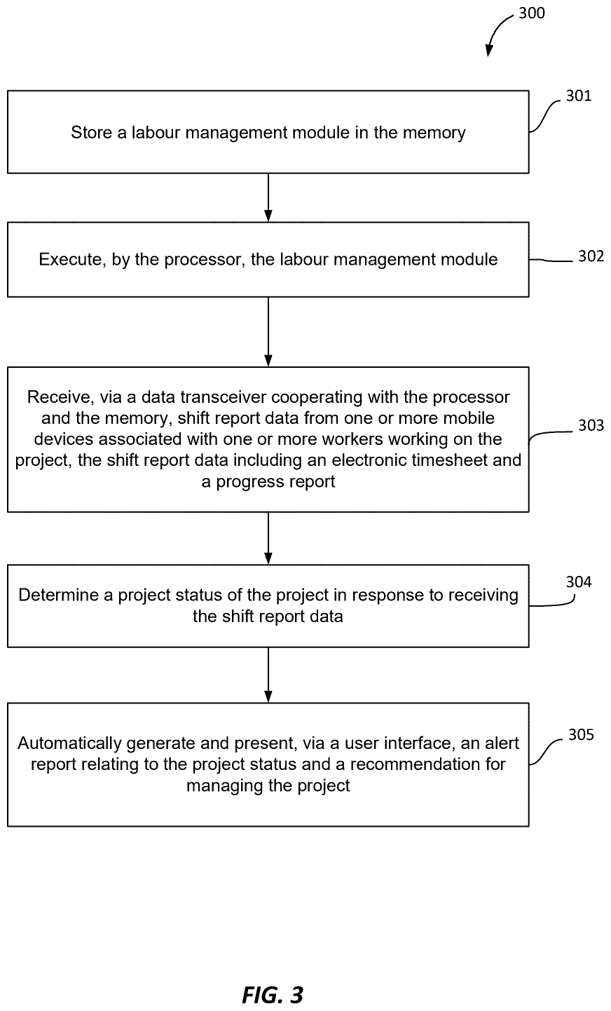

With respect to the embodiment of FIG. 1, this system can be used to perform a novel computer-implemented method 300 that is outlined in FIG. 3 for the purpose of managing labour in a project. As depicted by way of example in FIG. 3, the method 300 entails a step, act or operation of storing 301 a labour management module in the memory and then executing 302, by the processor, the labour management module. The method 300 further entails receiving 303, via a data transceiver cooperating with the processor and the memory, shift report data from one or more mobile devices associated with one or more workers working on the project, the shift report data including an electronic timesheet and a progress report. The method 300 further entails determining 304 a project status of the project in response to receiving the shift report data and automatically generating and presenting 305, via a user interface, an alert report relating to the project status and a recommendation for managing the project.

In a more specific implementation, the method 300 may involve the following steps, acts or operations:

For each contractor crew, a shift report will be completed usually by the foreman, using a handheld device provided by the project owner, by the contractor, or by using the foreman's or employee's own device(s). The superintendent or other responsible party will review the shift reports, and either approve, dispute, or return for correction. The superintendent or other responsible party will complete and approve the physical progress report. Once approved, field data from shift and physical progress reports will be uploaded to the labour management module which will forecast labour costs by comparing labour costs to date with physical progress. The forecasted labour costs will be included in a contract status report. The key tool used to collect field data will be the shift report, which is an electronic timesheet that also tracks physical progress against milestones. Information in the shift report will include contract number, employee name, worker ID, trade union, location, job classification, shift type, date, start and end time, and physical progress against milestones. There will also be space in the shift report to upload photos of issues or delays, such as equipment breakdowns. The shift report will be very easy to complete, as most fields will be prepopulated and there will only be 5 to 10 predefined milestones.

The labour management module will apply the field data against business rules stored in a memory or database by the module or in a memory or database that is accessible by the module. If the field data meets the criteria of a business rule, the system will create an alert, optionally containing recommendations. The alerts may optionally be consolidated in an alert report.

The labour management module will review and approve the alert report. Optionally, functionality is provided to manually change, edit or override automated alerts and/or recommendations.

Once the alert report is approved, the labour management module will generate management reports. Alert types will be mapped to different management reports including an exception log, Superintendent report, Project Manager report, Contract Manager report, and Project Director report. Management will review the reports and make labour management decisions in real-time.

Optionally, the labour management module will automatically generate invoices and payroll reports from the field data as required.

This technology enables management to identify potential issues and take corrective action before the issues lead to significant cost and schedule overruns.

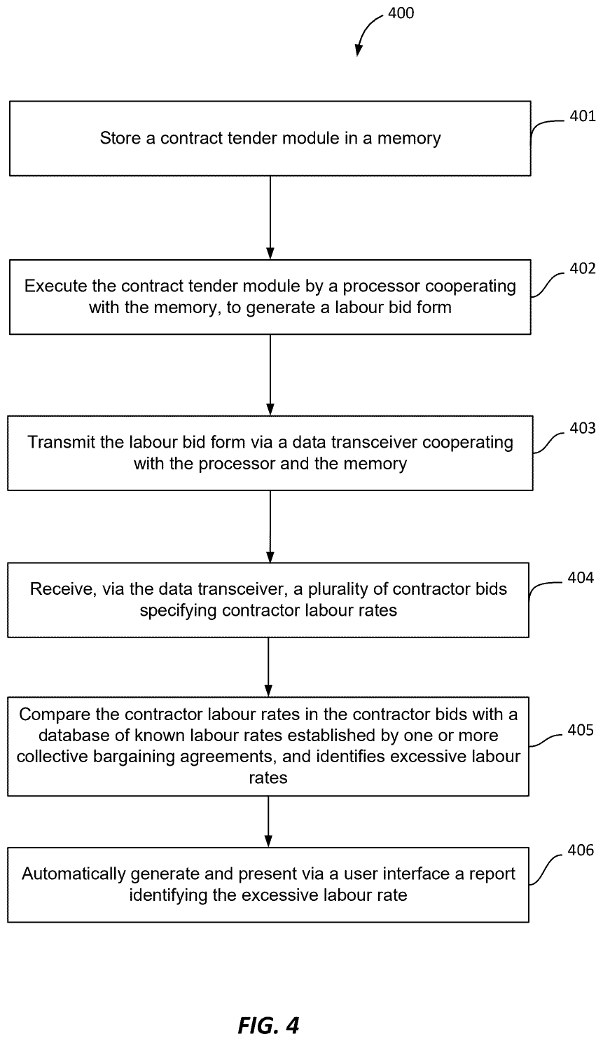

With respect to the embodiment depicted by way of example of FIG. 2, this system can be used to perform a novel computer-implemented method 400 that is outlined in FIG. 4 for the purposes of creating contract tenders. As depicted by way of example in FIG. 4, the method 400 entails a step, act or operation of storing 401 a contract tender module in a memory and then executing 402 the contract tender module by a processor cooperating with the memory, to generate a labour bid form. The method 400 entails transmitting 403 the labour bid form via a data transceiver cooperating with the processor and the memory. The method 400 further entails receiving 404, via the data transceiver, a plurality of contractor bids specifying contractor labour rates. The contract tender module executed by the processor compares 405 the contractor labour rates in the contractor bids with a database of known labour rates established by one or more collective bargaining agreements, and identifies excessive labour rates. The method 400 further entails automatically generating and presenting 406 via a user interface a report identifying the excessive labour rates.

In a more specific implementation, the method 400 may involve the following steps, acts or operations: The contract tender module generates an electronic bid form (“labour bid form”) that includes CBA rates for each labour code. The project owner will issue the bid documents, including the labour bid form, to contractors. Contractors will prepare and submit the bid documents. The labour bid form will calculate the contractors' margins by comparing the contractors' labour rates to the relevant CBA rates. Once submitted, the labour bid form will be uploaded to the contract tender module or to a bid comparison dashboard. If applicable, a procurement team will compare the fixed price components of each bid. The procurement team will evaluate each contractor's ability to execute the project. The procurement team will use the bid comparison dashboard to identify excessive labour rates for time and material (T&M) work that require further negotiation. The procurement team will award the contract. This method uses CBA rates, which reflect the labour costs to the contractor, to accurately identify contractor margins. This enables the procurement team to identify excessive labour rates and negotiate them down.

Another aspect of the disclosure is a system for measuring labour costs that detects worker presence to determine worker wages and thus to calculate or estimate project costs or incremental (or daily) project costs. In this system, a mobile device may be used by one or more workers or the foreman (jobsite supervisor) of the one or more workers to report work data such as hours worked, tasks completed, etc. This self-reported worker data provides a baseline or starting point for computing the labour costs. To more accurately assess the worker costs (labour costs) and/or to validate the self-reported worker data, the system includes one or more worker detection and reporting devices that sensor or detect worker presence to more accurately measure actual hours of work performed by the workers. For example, a drone or unmanned aerial vehicle having a camera may capture imagery, either continuously or intermittently, to count how many workers are present on the jobsite and optionally to observe the movements or tasks of the workers or of vehicles, supplies being delivered or waste leaving the site. To facilitate detection, the one or more workers may wear wearable sensors such as smart watches, smart helmets, RFID tags, or other such RF-emitting device. A Wi-Fi wireless access point may record the number of wireless devices that are connected to it as a way to infer the number of workers at a jobsite. The connectivity data may allow inference of when workers arrived at the jobsite and when they left the jobsite. A perimeter access may have a proximity card or NFC reader to record entry into the jobsite by each worker. These various detection techniques can be used singly or in any suitable combination to generate worker presence data indicating how many workers showed up at the jobsite and how long they were present on the jobsite. This enable computation of wages by extracting rates from the appropriate contractual source such as a collective bargaining agreement.

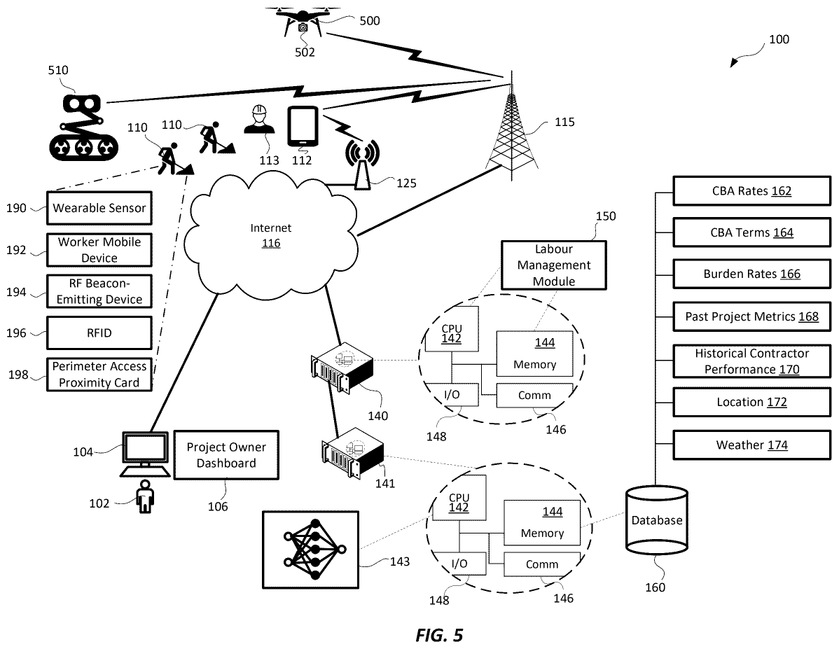

In various embodiments, as depicted in FIGS. 5-8, the system for managing a project comprises a worker detection and reporting device for detecting one or more workers working at a site of the project. The worker detection and reporting device has a processor, a memory coupled to the processor and a short-range wireless receiver coupled to the processor to detect short-range wireless signals from a plurality of worker devices associated with workers working the site of the project. The short-range wireless signal has a maximum signal range of 1 km. The processor of the worker detection and reporting device is configured to determine worker presence for the workers based on the short-range wireless signals from the plurality of worker devices and to generate shift report data for the workers indicative of work hours completed for a work shift at the site. The worker detection and reporting device has a cellular radiofrequency transceiver to transmit the shift report data via a base transceiver station and the internet. The system further includes a server comprising a server memory, a server processor, and a server data transceiver for receiving the shift report data from the worker detection and reporting device and also receiving progress data indicative of progress made on the project. The server memory and the server processor store and execute a labour management module having, or interacting with, an artificial intelligence module trained on past project data, the artificial intelligence module analyzing the shift report data to determine if the shift report data complies with contractual requirements and correlates to expected progress on the project and to generate an alert report if the shift report data does not comply with the contractual requirement or does not correlate to the expected progress on the project. The system further includes a computing device associated with a project owner. The computing device comprises a device memory, a device processor and a device data transceiver to communicatively connect the computing device via the internet to the server to receive the alert report. The computing device has a user interface cooperating with the device processor to present the alert report to the project owner.

In the embodiment depicted in FIG. 5, the system denoted generally by reference numeral 100 enables a project owner or user 102 to view or track project costs, and in particular labour costs, presented by a user computing device (project owner computing device) 104 via a project owner dashboard displayed by a user interface (or display) of the user computing device 104. The user computing device may be a desktop computer, laptop computer, tablet or mobile device. The user computing device includes a processor, memory and data transceiver to connect to the internet 116. In the embodiment of FIG. 5, the system includes a server 140 that has a server processor (CPU) 142, server memory 144 and server data transceiver (communications port) 146 to connect to the internet 116 and input/output (I/O) device 148. The server memory 144 stores a labour management module 150. The server processor 142 executes the labour management module 150. The labour management module 150 computes labour costs based on the worker hours reported and the appropriate contractual terms by determining the appropriate rates based on the applicable collective bargaining agreement. In the embodiment of FIG. 5, the server 140 may execute an artificial intelligence (AI) module 143 or a separate AI server 141 may be provided to execute the AI module 143. The AI server 141 has a CPU 142, memory 144, communications port 146 and I/O device 148. The memory 144 of the AI server 141 may store a database 160. The database 160 may store data relating to collective bargaining agreement rates 162, collective bargaining agreement terms 164, burden rates 166, past project metrics 168, historical contractor performance 170, location 172 and weather 174. The AI module 143 may have an AI model trained to learn how these parameters affect the labour costs. The AI module in cooperation with the labour management module may then determine labour costs based on reported shift data.

In the embodiment of FIG. 5, the worker detection and reporting device (WDRD) 112 is a mobile device (mobile communication device or wireless communication device), e.g. a smartphone, tablet or other such device. In the example of FIG. 5, the WDRD 112 is the mobile device operated by a foreman 113 or jobsite supervisor. In a variant, each worker 110 can report his own shift data, i.e. each mobile device 112 of each worker 110 can be its own WDRD in another implementation. In the example of FIG. 5, the foreman's mobile device 112 is the WDRD that sends the shift reporting data for all workers 110 on the jobsite via the base transceiver station 115 through the internet 116 to the server 140 to be processed by the labour management module 150. In this example depicted in FIG. 5, the WDRD 112 of the foreman 113 detects the presence of the workers 110 by various means such as by receiving wireless signals from one or more sources that indicate the presence of the workers. For the purposes of this disclosure, the expression “worker devices” shall be construed broadly to mean any device worn or carried by the worker that emits a signal to indicate the presence of the worker.

In one embodiment of the system shown in FIG. 5, the plurality of worker devices 112 associated with workers 110 are wearable sensors 190 worn by the workers 110. In this case, the worker detection and reporting device 112 receives the short-range wireless signals from the wearable sensors 190 to determine the worker presence. The wearable sensors 190 may be, for example, smart watches, smart rings, smart glasses, smart clothing or exoskeletons that include Bluetooth transceivers or other signal-emitting transmitters. The worker detection and reporting device 112 detects the worker presence by detecting, for example, Bluetooth signals from the Bluetooth transceivers of the smart watches, smart rings, smart glasses, smart clothing or exoskeletons.

Optionally, and subject to appropriate consent from the workers, the worker detection and reporting device 112 also receives biometric data from the wearable sensors 190. Optionally, to protect personal privacy of the workers, the worker detection and reporting device 112 executes a data anonymizer to anonymize the biometric data to provide anonymized biometric data to the server 140. For example, this may indicate the average number of steps, calories burned, distance travelled, etc. of the workers. This biometric data may be used to assess the activity level of the workers.

In one embodiment of the system shown in FIG. 5, the plurality of worker devices associated with workers are mobile communication devices 192 (wireless communication devices, e.g. smart phones) carried by the workers. The worker detection and reporting device 112 receives the short-range wireless signals from the mobile communication devices 192 to determine the worker presence. For example, the mobile communication devices 192 may broadcast Wi-Fi signals or Bluetooth signals, and the worker detection and reporting device 112 detects the Wi-Fi signals or the Bluetooth signals from the mobile communication devices 192 to determine the worker presence.

In one embodiment of the system shown in FIG. 5, the plurality of worker devices associated with workers are wearable RF beacon-emitting devices 194 worn by the workers and the worker detection and reporting device 112 receives the short-range wireless signals from the wearable RF beacon-emitting devices 194 to determine the worker presence. For example, the wearable RF beacon-emitting devices comprises one or more personal protective devices, e.g. construction helmets, high-visibility vest, etc. worn by the workers having an RF beacon emitter that emits an RF beacon, and wherein the worker detection and reporting device detects the RF beacon to determine the worker presence.

In one embodiment of the system, the plurality of worker devices associated with workers are RFID tags 196 worn by the workers and detected by RFID detectors at the site. For example, various RFID readers may be placed at locations through the construction site in order to track the workers. The worker detection and reporting device may receive signals from the RFID detectors to determine the worker presence. Alternatively, the RFID detectors may be networked to a central monitoring device, hub or aggregator that transmits location information to the worker detection and reporting device. Data may be transmitted periodically, intermittently, continuously (on detection). Data may be pushed to the worker detection and reporting device or pulled by the worker detection and reporting device.

In one embodiment of the system, the plurality of worker devices associated with workers are perimeter access proximity cards (or NFC) 198 carried by the workers and detected by a proximity card reader (or NFC reader) at the site. For example, there may be a fence with an entry point or gate that has a proximity card reader or NFC reader. Each worker swipes his card to enter the site (and may optionally swipe the card when leaving). The worker detection and reporting device receives signals from the proximity card reader or NFC reader to determine the worker presence at the site.

In the embodiment shown in FIG. 5, the worker detection and reporting device 112 is a wireless communication device, e.g. smartphone, operated by a foreman (or site supervisor) at the site. Alternatively, or additionally, the worker detection and reporting device may be a drone 500 such as unmanned aerial vehicle (UAV). The drone 500 may have a camera 502 to capture time-stamped images (or video) of the jobsite, to count the number of workers present, the number of vehicles present, the amount of material being delivered, the amount of waste been trucked out and/or to capture images of construction progress. Alternatively, or additionally, the worker detection and reporting device may be a land-based robotic inspection vehicle 510 which may have a camera to capture time-stamped images (or video) of the jobsite, to count the number of workers present, the number of vehicles present, the amount of material being delivered, the amount of waste been trucked out and/or to capture images of construction progress.

In some instances, the construction project or jobsite may have a local Wi-Fi access point or Wi-Fi router 125 that enables the worker presence and reporting device 112 to transmit the shift report data via the Internet 116 to the server 140. Furthermore, the Wi-Fi access point 125 may be used as a way to detect worker presence. The Wi-Fi access point 125 may log or record the identity of each wireless communications device that connects to the Wi-Fi access point 125. The Wi-Fi access point 125 may log the time of the connection and when the connection is lost, thus generating worker connectivity data. These times may be used to infer how long the worker was present at the jobsite. The Wi-Fi access point 125 may share the worker connectivity data with the worker presence and reporting device 112 to enable the worker presence and reporting device 112 to generate shift report data for communicating to the server 140. The worker presence and reporting device may also be referred to herein as a worker detection and reporting device.

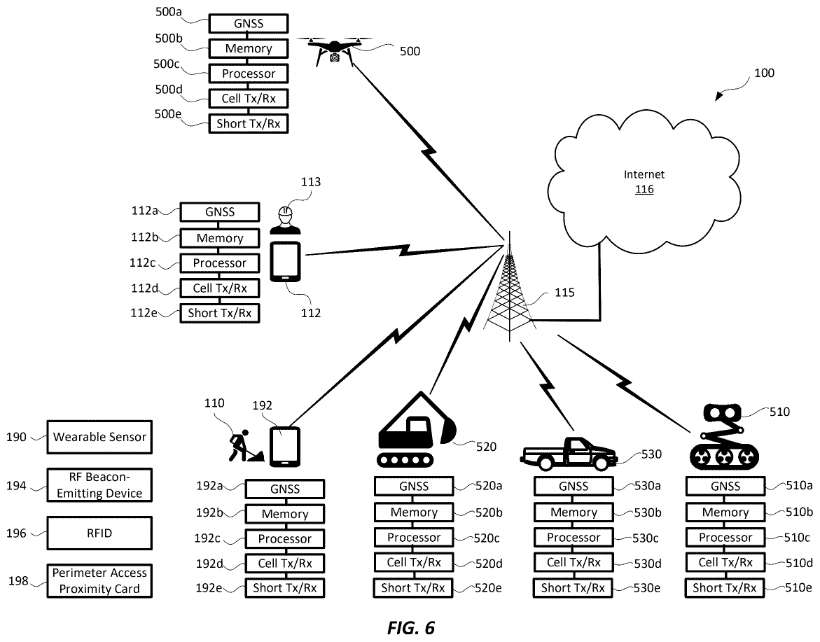

FIG. 6 depicts a system showing various types of worker detection and reporting devices. Any one or more of these worker detection and reporting devices may be used together (e.g. concurrently) to detect worker presence and to report shift data.

In one embodiment, as shown by way of example in FIG. 6, the worker detection and reporting device is a wireless communication device (mobile communication device) 112 carried by, or otherwise associated with, the foreman 113 supervising the workers 110 at the jobsite. The wireless communication device 112 includes a GNSS receiver 112a, a memory 112b, a processor 112c, a cellular transceiver 112d (denoted “Cell Tx/Rx”) and a short-range wireless transceiver 112e (denoted “Short Tx/Rx”). The wireless communications device 112 can report time-stamped location data using the GNSS receiver 112a to prove worker presence (or absence) at a jobsite. The wireless communications device 112 can detect worker presence by detecting short-range wireless signals from worker wireless devices using the short-range wireless transceiver 112e. The wireless communications device 112 can report shift data using the cellular transceiver 112d by transmitting the shift data via the base station transceiver 115 via the Internet 116 to the server 140 shown in FIG. 5. As noted above, worker presence may also be reported directly by each worker's own wireless communications device 192. Each wireless communications device 192 has a GNSS receiver 192a, a memory 192b, a processor 192c, a cellular transceiver 192d (denoted “Cell Tx/Rx”) and a short-range wireless transceiver 192e (denoted “Short Tx/Rx”). The wireless communications device 192 can report time-stamped location data using the GNSS receiver 192a to prove worker presence at a jobsite. The wireless communications device 192 can broadcast short-range wireless signals (using the short-range wireless transceiver 112e) to the short-range wireless transceiver 112e of the foreman's wireless communications device 112 to establish presence at the jobsite. The wireless communications device 192 can optionally report its own shift data using the cellular transceiver 192d by transmitting the shift data via the base station transceiver 115 via the Internet 116 to the server 140 shown in FIG. 5.

In other embodiments, the worker detection and reporting device is a robotic inspection vehicle. The robotic inspection vehicle may have a navigation subsystem for autonomously traveling to and around the site to inspect the site. Alternatively, the robotic inspection vehicle may be user-driven or remotely piloted by radio control. In one particular implementation, the robotic inspection vehicle is an unmanned aerial vehicle (UAV) 500. The UAV (drone) 500 may have a camera to capture images of project progress and of workers or their vehicles parked at the site to enable the server to measure or infer worker presence. The robotic inspection vehicle may be a land-based robotic vehicle 510 or other autonomous land vehicle (e.g. the autonomous land vehicle may be a wheeled vehicle or a tracked vehicle).

In one embodiment shown in FIG. 6, as introduced above, the worker detection and reporting device is a drone 500. The drone 500 includes a GNSS receiver 500a, a memory 500b, a processor 500c, a cellular transceiver 500d (denoted “Cell Tx/Rx”) and a short-range wireless transceiver 500e (denoted “Short Tx/Rx”). The drone 500 can report time-stamped location data using the GNSS receiver 500a to prove worker presence (or absence) at a jobsite. The drone 500 can detect worker presence by detecting short-range wireless signals from worker wireless devices using the short-range wireless transceiver 500e. The drone 500 can report shift data using the cellular transceiver 500d by transmitting the shift data via the base station transceiver 115 via the Internet 116 to the server 140 shown in FIG. 5.

In one embodiment shown in FIG. 6, as introduced above, the worker detection and reporting device is a land-based robotic inspection vehicle 510. The robotic inspection vehicle 510 includes a GNSS receiver 510a, a memory 510b, a processor 510c, a cellular transceiver 510d (denoted “Cell Tx/Rx”) and a short-range wireless transceiver 510e (denoted “Short Tx/Rx”). The robotic inspection vehicle 510 can report time-stamped location data using the GNSS receiver 500a to prove worker presence (or absence) at a jobsite. The robotic inspection vehicle 510 can detect worker presence by detecting short-range wireless signals from worker wireless devices using the short-range wireless transceiver 510e. The robotic inspection vehicle 510 can report shift data using the cellular transceiver 510d by transmitting the shift data via the base station transceiver 115 via the Internet 116 to the server 140 shown in FIG. 5.

In another embodiment depicted by way of example in FIG. 6, the worker detection and reporting device is a construction vehicle 520 located at the jobsite. The construction vehicle may be an excavator, bulldozer, dump truck, cement truck, mobile crane, etc. The construction vehicle 520 includes a GNSS receiver 520a, a memory 520b, a processor 520c, a cellular transceiver 520d (denoted “Cell Tx/Rx”) and a short-range wireless transceiver 520e (denoted “Short Tx/Rx”). The construction vehicle 520 can report time-stamped location data using the GNSS receiver 520a to prove worker presence (or absence) at a jobsite. The construction vehicle 520 can detect worker presence by detecting short-range wireless signals from worker wireless devices using the short-range wireless transceiver 520e. The construction vehicle 520 can report shift data using the cellular transceiver 520d by transmitting the shift data via the base station transceiver 115 via the Internet 116 to the server 140 shown in FIG. 5.

In another embodiment depicted by way of example in FIG. 6, the worker detection and reporting device is a passenger vehicle 530 parked at the jobsite. The passenger vehicle may be a car, pickup truck, van, etc, that is used to transport workers to the jobsite. The passenger vehicle 530 includes a GNSS receiver 530a, a memory 530b, a processor 530c, a cellular transceiver 530d (denoted “Cell Tx/Rx”) and a short-range wireless transceiver 530e (denoted “Short Tx/Rx”). The passenger vehicle 530 can report time-stamped location data using the GNSS receiver 530a to prove worker presence (or absence) at a jobsite. The passenger vehicle 530 can detect worker presence by detecting short-range wireless signals from worker wireless devices using the short-range wireless transceiver 530e. The passenger vehicle 530 can report shift data using the cellular transceiver 530d by transmitting the shift data via the base station transceiver 115 via the Internet 116 to the server 140 shown in FIG. 5.

One or more of the short range wireless transceivers 112e, 500e, 510e, 520e, 530e may detect short range wireless signals (e.g. Bluetooth, Wi-Fi, etc.) emitted by the short-range wireless transceiver 192d of the worker's wireless communications device 192 to detect worker presence. One or more of the short range wireless transceivers 112e, 500e, 510e, 520e, 530e may also or alternatively detect short range wireless signals from wearable sensors 190, RF beacon-emitting devices 194, RFID readers 196 or perimeter access devices 198 to detect worker presence.

In one embodiment, the server 140 may query any of the worker detection and reporting devices 112, 192, 500, 510, 520, 530 to request time-stamped GNSS location data. If the server detects an anomaly in the worker shift reporting data, the server 140 can ask any one or more of the worker detection and reporting devices 112, 192, 500, 510, 520, 530 to share its time-stamped GNSS location data as a means to verify the shift reporting data that the server has received. In a variant, time-stamped location information determined from the nearest base transceiver station 115 (using e.g. Carrier Base Station Positioning) may also be collected and stored in one or more of the memories 112b, 192b, 500b, 510b, 520b, 530b as a further verification to prove location. Time-stamped location information can be used to prove or infer worker presence at a jobsite.

In a variant, the worker detection and reporting devices 112, 192, 500, 510, 520, 530 may be configured optionally to automatically share and store time-stamped GNSS location data with each other. For example, the GNSS data from the GNSS receiver 530a of the passenger vehicle may automatically be shared and stored by the memory 510b of the robotic inspection vehicle 510 so that the server 140 can query any of the worker detection and reporting devices 112, 192, 500, 510, 520, 530 to obtain location information about any other one of the worker detection and reporting devices 112, 192, 500, 510, 520, 530.

In some embodiments, in the system of FIG. 6 the presence of passenger vehicles 530 parked at the jobsite may be detected as a way to infer worker presence and/or to validate the worker presence detected by other means. For example, if the shift report data indicates that large number of workers are on site but only a few passenger vehicles are parked at the jobsite, the server may generate an alert or request to validate the shift report data. The presence of passenger vehicles 530 may be detected by sensing short-range wireless signals emitted by the short-range wireless transceiver 530d of each passenger vehicle 530. In a variant, the drone 500 or robotic inspection device 510 may capture images of the passenger vehicles 530 to identify each type of passenger vehicle from which the server may calculate the maximum number of passengers that the passenger vehicles can carry and then use this information to validate the worker shift data. In a similar vein, construction vehicles located at the jobsite can be used as a proxy to infer worker presence. If certain construction vehicles are essential for the construction being performed, the presence of construction vehicles can be used to infer or validate shift reporting data. The presence of the construction vehicles can be detected by sensing short-range wireless signals emitted by the short-range wireless transceiver 520e of each construction vehicle 520. In a variant, the drone 500 or robotic inspection device 510 may capture images of the construction vehicle(s) 520. The images may be time-stamped.

Worker presence at a jobsite may be sensed using one or more presence indicators. The labour management module 150 executed by the server 140 may be configured to accept only a single data source (a single presence indicator) or may be configured to require more than a single data source (more than a single presence indicator).

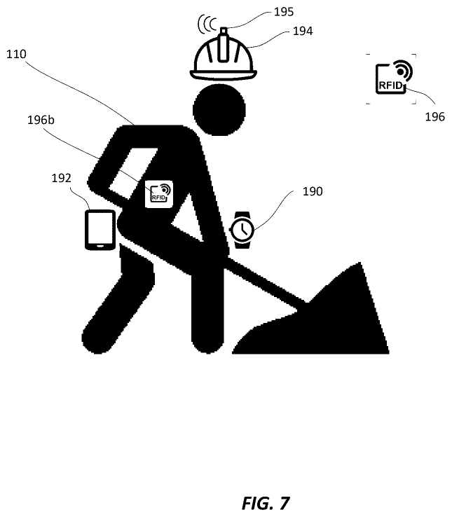

FIG. 7 is a schematic illustration of a worker 110 wearing multiple presence indicators. In the example depicted in FIG. 7, the worker 110 is wearing a smart watch as an example of a wearable sensor 190. Instead of the smart watch, the worker could wear a smart ring, smart jewelry, smart clothing or exoskeleton. The worker 110 in the example of FIG. 7 is also shown carrying a mobile communication device 192 such as a smart phone. The worker 110 in FIG. 7 is also wearing a smart helmet 194 emitting an RF beacon from a beacon-emitting device 195 mounted on the helmet. The worker 110 in FIG. 7 is also wearing an RFID tag 196b detectable by an RFID reader 196. All of these presence indicators can be detected by a worker presence and reporting device 112 ether directly by sensing the presence indicator directly, e.g. using the short-range wireless transceiver as described above, or indirectly via a data hub or aggregator that senses the presence indicator and then rebroadcasts (i.e. transmits) it to the worker presence and reporting device 112.

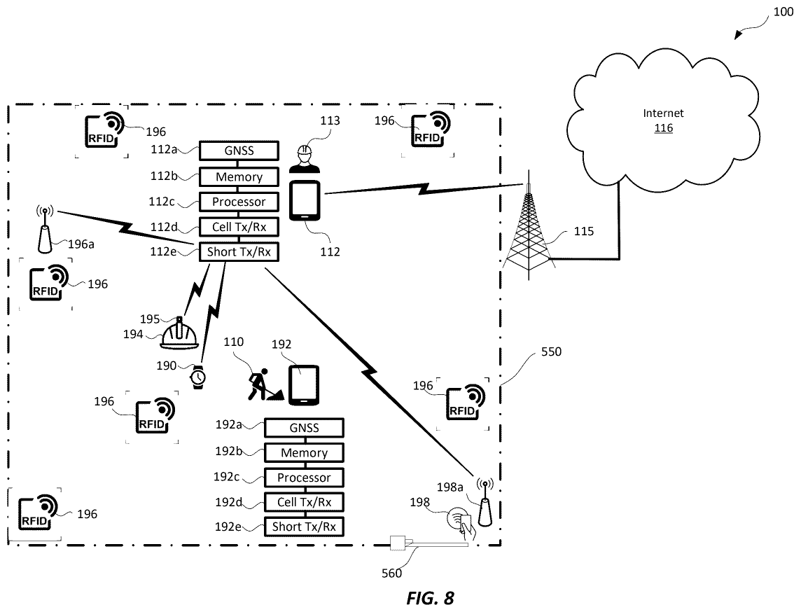

FIG. 8 is a schematic depiction illustrating how a worker detection and reporting device 112 can operate at a project site having various types of presence indicators including RFID and proximity card presence indicators. FIG. 8 schematically illustrates a project site enclosed by a fence 550 and gate 560. In this example, the worker detection and reporting device 112, which is in this example a smart phone of a foreman 113, has a short-range wireless transceiver 112e capable of detecting worker presence by receiving short-range wireless signals from the short-range wireless transceiver 192e of the mobile communication device 192 carried by the worker 110. The short-range wireless transceiver 112e is also capable of detecting worker presence by receiving short-range wireless signals from a smart helmet 194 having an RF-emitting device 195 emitting an RF beacon. The short-range wireless transceiver 112e is also capable of detecting worker presence by receiving short-range wireless signals from a smart watch 190 worn by the worker 110. As further shown in FIG. 8, the short-range wireless transceiver 112e is also capable of detecting worker presence by receiving signals from one or more RFID readers 196 and/or from a proximity card reader 198. As illustrated by way of example in FIG. 8, there are multiple RFID readers 196 placed at various locations at the jobsite, i.e. within the fence 550 defining the perimeter of the jobsite. The RFID readers 196 detect the worker 110 when the worker 110 walks within range of one of the RFID readers 196. In other words, the RFID readers 196 detect the worker 110 when the worker is in proximity to any of the RFID readers 196. The RFID readers 196 may be connected or networked either wirelessly or by cable to a data hub or aggregator having a transmitter 196a that broadcasts or transmits the RFID data to the short-range wireless transceiver 112e of the worker presence and reporting device 112. The proximity card reader 198 also has a transmitter 198a to broadcast or transmit the proximity card data to the short-range wireless transceiver 112e of the worker presence and reporting device 112.

In one optional implementation, the drone or robotic inspection vehicle comprises a weather sensor to sense weather data (a weather state) at the site of the project. The weather sensor may include a thermometer, wind sensor, precipitation sensor, humidity sensor, etc. The cellular radiofrequency transceiver 500e, 510e of the drone 500 or robotic inspection vehicle 510 in this embodiment transmits the weather data indicative of the weather state via cellular transceiver 500d, 510d to the server to enable the server to estimate a construction delay due to the weather state. In a variant, the weather data indicative of the weather state may be obtained by any other of the worker detection and reporting devices such as the wireless communications devices 112, 192 or the construction vehicle 520 or passenger vehicle 530. The AI module 143 may receive weather data, worker shift data and progress data and correlate the progress data with the weather data (or the shift data to the weather data) to continually learn how the weather state affects progress and shift reporting. The AI module can then predict how future weather states will affect progress on the project and how this will impact labour cost. For example, extreme weather (e.g. extremely high or low temperatures, extremely high winds or extreme precipitation) may significantly affect productivity (efficiency) of the workers. Thus, the server 140 may recognize that progress is diminished due to the weather state and not due to worker issues.

In some embodiments of the system, the server 140 may be configured to detect an anomaly or discrepancy in the shift report data. The anomaly or discrepancy may be that the shift report data does not comply with the contractual requirements. The anomaly or discrepancy may be that the shift report data does not correlate to the expected progress on the project. The server 140 may be configured to, in response to detecting that the shift report data does not comply with the contractual requirements or does not correlate to the expected progress on the project, transmit a query to the worker detection and reporting device 112. In one of these embodiments, the detection and reporting device 112, in response to receiving the query, identifies the worker 110 who is subject to the query and transmits a confirmation request to the mobile communication device 192 of the worker to request worker confirmation to confirm or change the shift reporting data for the worker.

In one of these embodiments, the worker detection and reporting device 112, in response to receiving the query, identifies the worker who is subject to the query and transmits a confirmation request to the mobile communication device of the worker to request time and location data from the mobile communication device of the worker. In this embodiment, the mobile communication device, in response to receiving the confirmation request, generates time-stamped location data obtained from a GNSS cache stored in the memory 192b of the mobile communication device 192 to confirm that the worker 110 was present at the jobsite for a time indicated by the shift report data.

In another one of these embodiments, the worker detection and reporting device 112, in response to receiving the query, identifies the worker 110 who is subject to the query, further identifies a vehicle 530 associated with the worker 110, and transmits a confirmation request to the vehicle 530 associated with the worker 110 (e.g. by transmitting the confirmation request to cellular transceiver 530d) of the vehicle 530 to request time-stamped location data from the memory 530b of the vehicle 530 associated with the worker 110. In this embodiment, the vehicle 530 associated with the vehicle, in response to receiving the confirmation request, generates time-stamped location data obtained from a GNSS cache stored in a memory 530b of the vehicle 530 to confirm that the vehicle 530 associated with the worker 110 was present at the jobsite for a time indicated by the shift report data.

In the foregoing embodiments, the worker is understood to be a human worker. However, in another implementation, the worker may be a robotic (non-human) worker, e.g. stationary or autonomously moving robotic machinery, equipment or apparatus or a humanoid robotic worker. Each of these types of robotic worker may include a robotic arm, manipulator or end-effector having one or more grasping elements for grasping tools or other objects for building or construction. The robotic worker may have a machine-vision subsystem having one or more cameras for capturing images or video of a surrounding environment and one or processors for executing machine-vision algorithms, methods or code to process the images or video to recognize features of the surrounding environment and to control the robotic arm, manipulator end-effector to perform tasks such as cutting, drilling, fastening, hammering, etc. In the implementation of a robotic worker, the worker presence and reporting device may receive via the short-range wireless transceiver of the worker presence and reporting device a short-range wireless signal or signals from the robotic worker to indicate its presence at the project site. The robotic worker may also transmit telemetry data and/or activity reports to the worker presence and reporting device to indicate how long it is working and/or what tasks it has completed during the work shift.

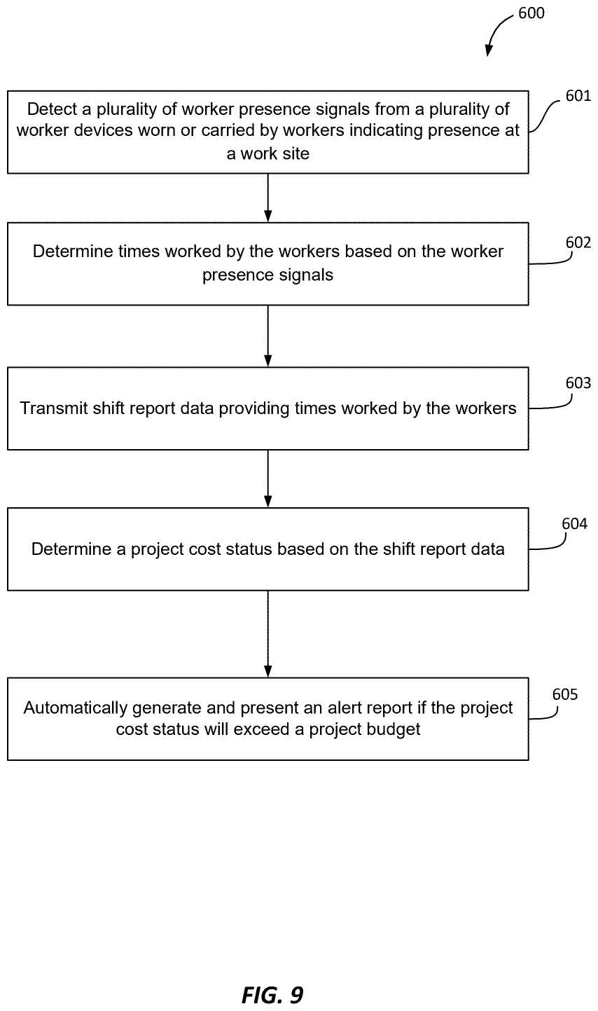

FIG. 9 is a flowchart depicting a computer-implemented method of detecting worker presence, determining times worked by the workers, transmitting shift report data to a server to assess project cost and to generate an alert report. As shown in FIG. 9, the method 600 includes a step 601 of detecting a plurality of worker presence signals from a plurality of worker devices worn or carried by workers indicating presence at a work site. The method 600 entails a step 602 of determining times worked by the workers based on the worker presence signals. The method 600 also entails a step 603 of transmitting shift report data providing times worked by the workers. The method 600 also includes a step 604 of determining a project cost status based on the shift report data. The method 600 further includes a step 605 of automatically generating and presenting an alert report if the project cost status will exceed a project budget. Step 605 may optionally also include a step of sending the alert report to another computing device such as to the superintendent computing device 122 for display on the superintendent dashboard 124 and/or to the project manager computing device 132 for display on the project manager dashboard 134.

In the foregoing description, the artificial intelligence (AI) module 143 develops an AI model that is able to automatically manage labour costs and to form contract tenders. The AI model can be trained to review union agreements and collective bargaining agreements to extract hourly rates and terms using natural language processing (NLP). The following steps may be used to train the AI model.

In a data collection step, a large dataset of union agreements in the construction industry is collected. Such agreements would cover a wide range of terms, including hourly rates, working conditions, benefits, and any other relevant information.

In a data preprocessing step, the collected data is cleaned and preprocessed to remove any irrelevant or redundant information. This step removes formatting inconsistencies, standardizes language, and organizes the data into a structured format.

In a labeling step, the data is labeled (or annotated) by labeling the relevant sections that contain hourly rates and terms. This enables the AI model to identify and extract the desired information accurately.

Model training is then performed by using machine learning techniques to train the AI model on the annotated data. Techniques such as named entity recognition (NER) and information extraction can be employed to teach the model to identify and extract hourly rates and terms from the union agreements.

Validation and refinement are then performed. This evaluates the trained model's performance by testing it on a separate validation dataset. This may involve an expert human validation of the results to train the AI model by confirming or correcting the AI model's learning. An expert human reviews the output of the AI model to determine if the AI model has learned to make correlations correctly.

In an integration step, once the AI model achieves satisfactory performance, the AI model is integrated into the AI module of the labour management module and/or into the contract tender module. The AI module can then receive new agreements as input, apply the trained model to extract relevant hourly rates and terms, and provide the extracted information at output for use in managing a project and/or in creating contract tenders.

In a further step of continuous learning and updating, as new union agreements become available, the AI module continues to collect and annotate relevant data to further train and improve the AI model. This ongoing process of continuing learning permits the model to remain up to date with the latest industry agreements and also the AI module to adapt to changes in the industry.

From the above description, is should be understood that either management of labour and/or creation of tenders can be performed using artificial intelligence or machine learning to perform one or more tasks in labour management and/or tender formation that could not be performed by a human or at least could not be performed efficiently by a human in a practical timeframe to be useful. The system, method or computer-readable medium disclosed in this specification may use various commands, queries, data flows, routines, data objects, data structures, etc., among elements of the software architecture (e.g., modules, network elements, device components, etc.) and data inputs to provide outputs in real time or near real time which are operations and processes that could not be practically performed manually or mentally by a human within the context of the disclosed embodiments.

Artificial neural networks or deep learning technologies can be used in the present embodiments for supervised and unsupervised learning. In supervised learning, models are trained using data that includes examples with inputs and outputs which the AI model learns to predict the outputs given the inputs. In unsupervised learning, no outputs are provided and the model instead learns to derive inferences from the data by itself. The most common type of unsupervised learning is clustering. Deep neural networks (DNNs) can also be used in the embodiments. A DNN may comprise an input layer, hidden layers, output layers, weights, biases, and activation functions. Examples of proprietary and open source deep learning platforms include Tensorflow, CNTK, Torch/Pytorch, and MXNet. DNN models (or in other instances non-DNN models) can use techniques such as, for example, support vector machines, Markov models, linear regression, logistic regression, and decision trees. In some embodiments, the AI module can include or implement perceptrons, multi-layer perceptrons, feedforward neural networks, convolutional neural networks (CNNs), and recurrent neural networks (RNNs). In the present embodiments, the AI module trains an AI model using a dataset of training data that enable the AI model to learn a correlation between a project event (e.g. an incorrect start time, incorrect end time, overworking by particular workers, et.) and a project outcome (e.g. time delay, cost overrun, etc). Once the AI model is trained, the AI model can be used by the AI module to automatically monitor progress of a project and to automatically generate alerts if the AI module detects one or more events that have an effect on the project outcome in terms of time and/cost.

These methods can be implemented in hardware, software, firmware or as any suitable combination thereof. That is, if implemented as software, the computer-readable medium comprises instructions in code which when loaded into memory and executed on a processor of a server or a user computing device causes the user computing device to perform any of the foregoing method steps. These method steps may be implemented as software, i.e. as coded instructions stored on a computer readable medium which performs the foregoing steps when the computer readable medium is loaded into memory and executed by the microprocessor of the mobile device. A computer readable medium can be any means that contain, store, communicate, propagate or transport the program for use by or in connection with the instruction execution system, apparatus or device. The computer-readable medium may be electronic, magnetic, optical, electromagnetic, infrared or any semiconductor system or device. For example, computer executable code to perform the methods disclosed herein may be tangibly recorded on a computer-readable medium including, but not limited to, a floppy-disk, a CD-ROM, a DVD, RAM, ROM, EPROM, Flash Memory or any suitable memory card, etc. The method may also be implemented in hardware. A hardware implementation might employ discrete logic circuits having logic gates for implementing logic functions on data signals, an application-specific integrated circuit (ASIC) having appropriate combinational logic gates, a programmable gate array (PGA), a field programmable gate array (FPGA), etc. For the purposes of this specification, the expression “module” is used expansively to mean any software, hardware, firmware, or combination thereof that performs a particular task, operation, function or a plurality of related tasks, operations or functions. When used in the context of software, the module may be a complete (standalone) piece of software, a software component, or a part of software having one or more routines or a subset of code that performs a discrete task, operation or function or a plurality or related tasks, operations or functions. Software modules have program code (machine-readable code) that may be stored in one or more memories on one or more discrete computing devices. The software modules may be executed by the same processor or by discrete processors of the same or different computing devices.

For the purposes of interpreting this specification, when referring to elements of various embodiments of the present invention, the articles “a”, “an”, “the” and “said” are intended to mean that there are one or more of the elements. The terms “comprising”, “including”, “having”, “entailing” and “involving”, and verb tense variants thereof, are intended to be inclusive and open-ended by which it is meant that there may be additional elements other than the listed elements.

This invention has been described in terms of specific implementations and configurations which are intended to be exemplary only. Persons of ordinary skill in the art will appreciate that many obvious variations, refinements and modifications may be made without departing from the inventive concepts presented in this application. The scope of the exclusive right sought by the Applicant(s) is therefore intended to be limited solely by the appended claims.

1. A system for managing a project, the system comprising:
a worker detection and reporting device for detecting one or more workers working at a site of the project, the worker detection and reporting device having:
a processor;
a memory coupled to the processor;
a short-range wireless receiver coupled to the processor to detect short-range wireless signals from a plurality of worker devices associated with workers working the site of the project, wherein the short-range wireless signal has a maximum signal range of 1 km,
wherein the processor of the worker detection and reporting device is configured to determine worker presence for the workers based on the short-range wireless signals from the plurality of worker devices and to generate shift report data for the workers indicative of work hours completed for a work shift at the site; and
a cellular radiofrequency transceiver to transmit the shift report data via a base transceiver station and the internet;
a server comprising a server memory, a server processor, and a server data transceiver for receiving the shift report data from the worker detection and reporting device and also receiving progress data indicative of progress made on the project, the server memory and the server processor storing and executing a labour management module having, or interacting with, an artificial intelligence module trained on past project data, the artificial intelligence module analyzing the shift report data to determine if the shift report data complies with contractual requirements and correlates to expected progress on the project and to generate an alert report if the shift report data does not comply with the contractual requirements or does not correlate to the expected progress on the project;
a computing device associated with a project owner, the computing device comprising a device memory, a device processor and a device data transceiver to communicatively connect the computing device via the internet to the server to receive the alert report, the computing device having a user interface cooperating with the device processor to present the alert report to the project owner.

2. The system of claim 1 wherein the plurality of worker devices associated with workers are wearable sensors worn by the workers and wherein the worker detection and reporting device receives the short-range wireless signals from the wearable sensors to determine the worker presence.

3. The system of claim 2 wherein the wearable sensors comprises smart watches, smart rings, smart glasses, smart clothing or exoskeletons that include Bluetooth transceivers and wherein the worker detection and reporting device detects the worker presence by detecting Bluetooth signals from the Bluetooth transceivers.

4. The system of claim 2 wherein the worker detection and reporting device also receives biometric data from the wearable sensors.

5. The system of claim 4 wherein the worker detection and reporting device anonymizes the biometric data to provide anonymized biometric data to the server.

6. The system of claim 1 wherein the plurality of worker devices associated with workers are wearable RF beacon-emitting devices worn by the workers and wherein the worker detection and reporting device receives the short-range wireless signals from the wearable RF beacon-emitting devices to determine the worker presence.

7. The system of claim 1 wherein the wearable RF beacon-emitting devices comprises one or more personal protective devices worn by the workers having an RF beacon emitter that emits an RF beacon, and wherein the worker detection and reporting device detects the RF beacon to determine the worker presence.

8. The system of claim 1 wherein the plurality of worker devices associated with workers are mobile communication devices carried by the workers and wherein the worker detection and reporting device receives the short-range wireless signals from the mobile communication devices to determine the worker presence.

9. The system of claim 8 wherein the mobile communication devices broadcast Wi-Fi signals or Bluetooth signals, and wherein the worker detection and reporting device detects the Wi-Fi signals or the Bluetooth signals from the mobile communication devices to determine the worker presence.

10. The system of claim 1 wherein the plurality of worker devices associated with workers are RFID tags worn by the workers and detected by RFID detectors at the site, wherein the worker detection and reporting device receives signals from the RFID detectors to determine the worker presence.

11. The system of claim 1 wherein the plurality of worker devices associated with workers are perimeter access proximity cards carried by the workers and detected by a proximity card reader at the site, wherein the worker detection and reporting device receives signals from the proximity card reader to determine the worker presence.

12. The system of claim 1 wherein the worker detection and reporting device is a wireless communication device operated by a foreman at the site.

13. The system of claim 1 wherein the worker detection and reporting device is a construction vehicle at the site.

14. The system of claim 1 wherein the worker detection and reporting device is a robotic inspection vehicle having the cellular radiofrequency transceiver to transmit the shift report data.

15. The system of claim 14 wherein the robotic inspection vehicle is an unmanned aerial vehicle (UAV) having a camera to capture images of project progress and vehicles parked at site to enable the server to infer worker presence.

16. The system of claim 14 wherein the robotic inspection vehicle comprises a weather sensor to sense a weather state at the site of the project, wherein the cellular radiofrequency transceiver of the robotic inspection vehicle transmits the weather state to the server to enable the server to estimate a construction delay due to the weather state.

17. The system of claim 1 wherein the server, in response to detecting that the shift report data does not comply with the contractual requirements or does not correlate to the expected progress on the project, transmits a query to the worker detection and reporting device.

18. The system of claim 17 wherein the detection and reporting device, in response to receiving the query, identifies the worker who is subject to the query and transmits a confirmation request to the mobile communication device of the worker to request worker confirmation to confirm or change the shift reporting data for the worker.

19. The system of claim 17 wherein the worker detection and reporting device, in response to receiving the query, identifies the worker who is subject to the query and transmits a confirmation request to the mobile communication device of the worker to request time and location data from the mobile communication device of the worker, wherein the mobile communication device, in response to the confirmation request, generates time-stamped location data obtained from a GNSS cache stored in a memory of the mobile communication device to confirm that the worker was present at the site for a time indicated by the shift report data.

20. The system of claim 17 wherein the worker detection and reporting device, in response to receiving the query, identifies the worker who is subject to the query, further identifies a vehicle associated with the worker, and transmits a confirmation request to the vehicle associated with the worker to request time and location data from the vehicle associated with the worker, wherein the vehicle associated with the vehicle, in response to the confirmation request, generates time-stamped location data obtained from a GNSS cache stored in a memory of the vehicle to confirm that the vehicle associated with the worker was present at the site for a time indicated by the shift report data.
